(19) United States
(12) Patent Application Publication
(10) Pub. No.: US 2013/0293037 A1
(43) Pub. Date: Nov. 7, 2013

(54) ROTATING ELECTRIC MACHINE

(71) Applicant: NIPPON PISTON RING CO., LTD, Saitama-shi (JP)

(72) Inventors: Masafumi SAKAMOTO, Shimotsuga-gun (JP); Shigeyoshi SATO, Shimotsuga-gun (JP); Shunsuke TAKEGUCHI, Shimotsuga-gun (JP)

(21) Appl. No.: 13/862,079

(22) Filed: Apr. 12, 2013

(30) Foreign Application Priority Data
Apr. 13, 2012 (JP) 2012-092270
Apr. 11, 2013 (JP) 2013-083226

(51) Int. Cl. H02K 1/27; H02K 3/12; H02K 1/02

(52) U.S. Cl. CPC H02K 1/278; H02K 1/276; H02K 1/02; H02K 3/12
USPC 310/44; 310/156.38; 310/156.53

(57) ABSTRACT

The disclosed is a rotating electric machine, comprising a magnetic iron stator and a surface permanent magnet type rotor, wherein a wire-winding axis and a rotating axial core of the stator cross each other orthogonally, and inner diameter portion of the stator is provided with an iron core having m wire-winding salient-poles arrayed circumferentially, and becomes gradually smaller from one side to another side in its axial direction, wherein the rotor has n poles with an arrangement that north poles and south poles are arrayed alternately in its circumferential direction, peripheral portion of the rotor becomes gradually smaller from one side to another side in its axial direction, and the stator and the rotor are engaged rotatably via a tapered air gap, wherein m is a positive integer of two or more, and n is a positive even number.

### TECHNICAL FIELD

This invention relates to a compact rotating electric machine.

### BACKGROUND ART

As for the compact or medium-sized rotating electric machine, of which power is about 1 KW or less, and that includes the electric motor and the electric generator, the demand of downsizing has been highly sought in the market. In addition, with respect to the electric motor, the demands of energy saving and high efficiency has been increased recently as measures for controlling global warming. Further, with respect to the electric generator, the demand of developing small-scale home generator has been also increased by reassessment of the natural energy in place of the nuclear energy household. Furthermore, the cheapness is also a strong demand.

With respect to the rotating electric machines, there are the radial gap type rotating electric machine and the axial gap type rotating electric machine. The former has been used widely as a general purpose machine, because air-gap thereof can be designed as a relatively small one and the opposed area at the air gap can be easily increased in the axis direction. However, as mentioned above, further improvements in the torque and the efficiency has been required. The latter axial gap type has an advantage for a flat and thin design, and can decrease the inertia when its rotor is formed as the geometry of a disc. Thus, the axial gap type is suitable for both of a constant speed operation and a variable speed operation, and it has come to attention recently. However, since the axial gap type is difficult to lessen its air-gap as compared with the radial gap type, it has problems in terms of the high-torque and the high-efficiency.

On the other hand, as a related technology for enhancing the torque in the prior art, the following patent literature would be mentioned. In this patent literature, the enhancement of torque is schemed by enlarging the opposed area.

### PRIOR ARTS' LITERATURE

### Patent Literature

(Patent Literature 1] WO 2010/116921

### SUMMARY OF INVENTION

### Problem to be Solved by the Invention

1) The rotating electric machines are divided roughly into the radial gap type and the axial gap type.

In the case of a brushless direct current motor (hereinafter, it is referred as to BLOC rotating electrical motor.) and a synchronous generator, both of which belong to the conventional generic radial gap type rotating electric machine and wherein a permanent magnet is used in the rotor thereof, or in the case of a switched reluctance motor (hereinafter, it is referred as to SR rotating electrical motor.) which is not use a permanent magnet in the rotor, but has magnetic blades, individual iron cores of stators are formed by laminating axially silicon steel plates. In addition, when attaching importance to the low cost and the efficiency, the concentrated winding system is adopted for winding. Because, when using the distribute winding system, the coil ends which cannot contribute to the torque generation becomes larger, thus, the copper loss increases and the efficiency decreases. In addition, when using the concentrate winding system, it is possible to wind coil directly to each slot since the winding is simple and thus the winding becomes low cost. In the case of the concentrated winding system, the number of slots in the stators may be restricted to be in the range of 4 to 12, in view of the practical construction, mainly because of the cost of the rotating machine.

On the other hand, although there are the axial gap type rotating electrical machine, it is hardly to reduce the air gap as compared with the radial gap type. Because, the axial gap type involves problems, such as, wobbling due to the plane-confrontation of air gaps. Therefore, the axial gap type is inferior to the radial gap type in accomplishing a high efficiency and a high torque. Assuming that the power of the axial gap type electric motor is equal to the power of the radial gap type electric motor, the outer peripheral of the axial gap type electric motor becomes larger than that of the radial gap type electric motor, because of the above-mentioned reason. Thus, the inertia of the rotor of the air gap type electric motor becomes larger. Therefore, the air gap type have not achieve widespread use as compared with the radial gap type, except for certain special usages such as electric motors of flat shape and electric motors which attach importance to a fixed velocity rotation without doing start-stop operations at frequent intervals. The present invention aims to provide a rotating electric machine that makes use of the merits both of the radial gap type and the axial gap type, that can assemble easily, that can have a performance roughly standing midway between the radial gape type and the axial gape type, and that can improve the efficiency dramatically.

2) As for a technology for enhancing the efficiency of the rotating electric machine, there is a means of enlarging the opposed area at the air gap between the rotor and the stator, which is disclosed in the above-mentioned patent literature 1. In this prior art's technology, an example for enhancing the torque of the SR motor as mentioned above which is represented by FIGS. 7 (a) and 7 (b) in the patent literature 1 is disclosed. However, in this example, the rotating electric machine is constituted so that the air gap is formed by engaging concavo-convex shapes with each other, but not formed linearly along the rotating axis. Thus, the substantial opposed area at the air gap becomes larger and the enhancement in the efficiency and the torque of the rotating electric machine can be attained. However, since the air gap of this rotating electric machine is not formed linearly, it is impossible to manufacture the rotor and the stator separately and assemble them into this machine so that the rotor is inserted into the stator. Therefore, an extended times are required to accomplish the assemblage of this machine including the wire winding operation as compared with a normal air gap type rotating electric machine in which the air gap is formed linearly along the axis direction, and the manufacturing cost becomes higher. The present invention also aims to solve this defect.
3) The coil ends of the concentrated winding system are smaller than those of the distribute winding method, and thus the copper loss can be repressed and the efficiency can be enhanced in the former method. However, in order to improve the efficiency still more, the use of area parts which are occupied by the coil ends and which does not constitute areas opposed to the rotor is required. As one means for solving the above-mentioned point, there is a technique in which a so-called overhang configuration where the individual winding poles of the stator is shaped so as to protrude in the axial direction or in the rotating circumferential direction is formed by the dust core. With respect to the silicon steel plates' lamination method, it is difficult to constitute such an overhang configuration in general. Alternatively, it ends in a result of a high cost even if realizing such an overhang configuration. Therefore, the dust core that can be formed in a three dimensional configuration has an advantage in forming such an overhang configuration. Herein, the dust core is the one which is manufactured by mixing a small amount of resin which functions as a binder and also as insulator for the eddy current to the soft magnetic powder, and compression molding the resultant mixture. The dust core has a feature that it can be molded as a three-dimensional complicated shape, while the silicon steel plates laminated type core is molded as a two-dimensional simple shape. In addition, the dust core has another feature that it has a reduced eddy current loss that is a part of the iron loss. Although the dust core as mentioned above has a disadvantage that its magnetic flux density is smaller than that of the silicon steel plates' lamination type core, it can be said that the dust core is suitable for accomplishing the high efficiency. Because, in the case of utilizing the overhang configuration, the areas opposed to the rotor becomes larger.

Moreover, it is necessary to enhance the space factor of winding in order to achieve a high efficiency. When winding a copper wire directly to slots in accordance with the concentrated winding system, the space factor of winding lies in the range of about 20% to about 30%. Because, the copper wire is wound by using a nozzle through opening parts of the slots. According to a split dust core as an aspect of the present invention, it is possible to enhance the space factor of winding to 60% or more in the lamination type dramatically. The present invention also aims to provide a constitution in which the effect due to the adoption of the dust core can be predominantly displayed.

### Means for Solving the Problems

According to the present invention, the means for solving the above-mentioned problems are realized concretely as follows:.

### <First Means>

A rotating electric machine comprising a rotor and a stator,

wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, and the inner diameter portion of which becomes gradually smaller with a linear or step-wise degression from one side to another side in its axial direction so as to form an air gap in a tapered or step-wise shape with the rotor,

wherein the rotor is one member selected from the group consisting of

(a) a surface permanent magnet type rotor, an outer peripheral portion of which becomes gradually smaller with a linear or step-wise degression from one side to another side in the axial direction so as to form the air gap in the tapered or step-wise shape with the stator, and the surface of which are magnetized by using permanent magnets so that n numbers of poles are formed with an arrangement that the north poles and the south poles are arrayed alternately in its circumferential direction; and
(b) an interior permanent magnet type rotor, an outer peripheral portion of which becomes gradually smaller with a linear or step-wise degression from one side to another side in its axial direction so as to form the air gap in the tapered or step-wise shape with the stator, and in which permanent magnets are embedded in holes provided on an iron core of the rotor in order that the iron core is magnetized so that n numbers of poles are formed with an arrangement that the north poles and the south poles are arrayed alternately in its circumferential direction,

wherein in represents a positive integer of two or more, and n represents a positive even number, and

wherein the stator and the rotor are engaged rotatably so as to be opposed to each other.

### <Second Means>

A rotating electric machine comprising a rotor and a stator,

wherein the stator has an inner diameter portion which becomes gradually smaller with a linear or step-wise degression from one side to another side in its axial direction so as to form an air gap in a tapered or step-wise shape with the rotor, and which is magnetized by adopting a surface permanent magnet type or an interior permanent magnet type configuration so that n numbers of poles are formed in its circumferential direction,

wherein the rotor is made of magnetic iron, a wire-winding axis and a rotating axial core of which cross each other orthogonally, and which comprises an iron core which has m numbers of wire-winding salient-poles which are arranged and distributed radially, and the outer peripheral portion of which becomes gradually smaller with a linear or step-wise degression from one side to another side in its axial direction so as to form the air gap in the tapered or step-wise shape with the stator,

wherein m represents a positive integer of two or more, and n represents a positive even number, and

wherein the stator and the rotor are engaged rotatably so as to be opposed to each other.

### <Third Means>

A rotating electric machine comprising a rotor and a stator,

wherein the rotor has an inner diameter portion which becomes gradually smaller with a linear or step-wise degression from one side to another side in its axial direction so as to form an air gap in a tapered or step-wise shape with the stator, and which is magnetized by adopting a surface permanent magnet type or an interior permanent magnet type configuration so that n numbers of poles are formed in its circumferential direction,

wherein the stator is made of magnetic iron, a wire-winding axis and a rotating axial core of which cross each other orthogonally, and which comprises an iron core which has m numbers of wire-winding salient-poles which are arranged and distributed radially, and the outer peripheral portion of which becomes gradually smaller with a linear or step-wise degression from one side to another side in its axial direction so as to form the air gap in the tapered or step-wise shape with the rotor,

wherein m represents a positive integer of two or more, and n represents a positive even number, and

wherein the stator and the rotor are engaged rotatably so as to be opposed to each other.

### <Fourth Means>

A rotating electric machine comprising a rotor and a stator,

wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, and the inner diameter portion of which becomes gradually smaller with a linear or step-wise degression from one side to another side in its axial direction so as to form an air gap in a tapered or step-wise shape with the rotor,

wherein the rotor is made of magnetic iron, and which comprises n numbers of salient-poles and the outer peripheral portion of which becomes gradually smaller with a linear or step-wise degression from one side to another side in its axial direction so as to form the air gap in the tapered or step-wise shape with the stator,

wherein m represents a positive integer of two or more, and n represents a positive even number, and

wherein the stator and the rotor are engaged rotatably so as to be opposed to each other.

### <Fifth Means>

A rotating electric machine comprising a rotor and a stator,

wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, wherein each individual wire-winding salient-pole has p numbers of teeth, and the inner diameter portion of which becomes gradually smaller with a linear or step-wise degression from one side to another side in its axial direction so as to form an air gap in a tapered or step-wise shape with the rotor,

wherein the rotor is positioned at the inner diameter portion of the stator, and the outer peripheral portion of which becomes gradually smaller with a linear or step-wise degression from one side to another side in its axial direction so as to form the air gap in the tapered or step-wise shape with the stator, and which is magnetized by permanent magnets so that q numbers of opposite poles are formed with an arrangement that the north poles and the south poles are arrayed alternately in its circumferential direction, or which comprises r numbers of salient poles in its circumferential direction,

wherein m, p and q represent an individual positive integer of two or more, and r represents a positive even number, and

wherein the stator and the rotor are engaged rotatably so as to be opposed to each other.

### <Sixth Means>

A rotating electric machine comprising a rotor and a stator,

wherein the stator is made of magnetic iron, a wire-winding axis and a rotating axial core of which cross each other orthogonally, and an outer peripheral portion of which is provided with an iron core which has m numbers of wire-winding salient-poles which are arranged and distributed circumferentially, wherein each individual wire-winding salient-pole has p numbers of teeth, and the outer peripheral portion of which becomes gradually smaller with a linear or step-wise degression from one side to another side in its axial direction so as to form an air gap in a tapered or step-wise shape with the rotor,

wherein the rotor is positioned outside of the stator, and the inner diameter portion of which becomes gradually smaller with a linear or step-wise degression from one side to another side in its axial direction so as to form the air gap in the tapered or step-wise shape with the stator, and which is magnetized by permanent magnets so that q numbers of opposite poles are formed with an arrangement that the north poles and the south poles are arrayed alternately in its circumferential direction, or which comprises r numbers of salient poles in its circumferential direction,

wherein m, p and q represent an individual positive integer of two or more, and r represents a positive even number, and

wherein the stator and the rotor are engaged rotatably so as to be opposed to each other.

### <Seventh Means>

The rotating electric machine according to one of the above-mentioned first means to the above-mentioned sixth means, wherein the magnetic iron is dust core.

### <Eighth Means>

The rotating electric machine according to one of the above-mentioned first means to the above-mentioned sixth means, wherein the magnetic iron is made both of dust core and silicon steel plates.

### <Ninth Means>

The rotating electric machine according to the above-mentioned seventh means or the above-mentioned eighth means, wherein a portion made of the dust core is provided with an overhang configuration having a wire-winding slot.

### <Tenth Means>

The rotating electric machine according to one of the above-mentioned first means to the above-mentioned ninth means, wherein the permanent magnets used in the surface permanent magnet type stator or rotor are magnetized with an angle which is not orthogonal to the rotating axis.

### <Eleventh Means>

The rotating electric machine according to one of the above-mentioned first means to the above-mentioned ninth means, wherein the permanent magnets used in the interior permanent magnet type stator or rotor, or split type permanent magnets used in the surface permanent magnet type stator or rotor show a trapezoid shape or a curved surface trapezoid shape in the thickness direction.

### Effect of the Invention

(1) Since the opposed portion between the stator and the rotor at the air gap comes to be in a tapered shape facing or a step-wise shape facing, it is possible to enlarge the opposed area, and thus a rotating electric motor which has an excellent air-gap permeance and a high efficiency can be realized.
(2) Since the shape of the inner diameter portion of the stator and the shape of the outer peripheral portion of the rotor are roughly conical, the assemblage and disassembling of the rotating electric motor, where the rotor is inserted in the stator, becomes very easy, and a rotating electric motor in a low cost can be realized.
(3) When the wire-winding part iron core is formed as the overhang type one having the wire-winding slot, it becomes possible to increase further the areas opposed to the rotor, or it is possible to decrease the copper loss, and thus a compact and high efficiency rotating electric motor can be realized.
(4) When the magnetic iron core of the stator or the rotor is made of the iron core by which a three-dimensional configuration can be easily molded, a rotating electric motor which is easily manufactured and is in a low cost can be realized.
(5) Since the eddy current loss comes to be near zero when using the dust core, it becomes possible to repress the iron loss, especially, at a high speed, and thus, a high efficiency rotating electric machine can be provided.
(6) When the magnetic iron core of the stator or the rotor is made of the silicon steel plates in a part, and if necessary, each side portion of the steel plates' part is made of the dust core and has the overhang configuration provided with the wire-winding slot, a rotating electric machine that operates with a further higher efficiency can be realized.
(7) When the permanent magnets to be used are magnetized in the direction perpendicular to a mean taper air gap, that is, perpendicular to the conical surface, an effect of equalizing the magnetic flux density at the air gap portion due to the permanent magnets in the rotating electric machine is expected, and, particularly, in the case of the step-wise shaped air gap, it becomes possible to enhance the axial direction component of the magnetic flux.
(8) When the embedded type permanent magnets to be used are the ones that each shows a trapezoid shape or a curved surface trapezoid shape, their insertion to holes becomes easier, and the magnetic flux density at the air gap portion due to the permanent magnets can be equalized.

### BRIEF EXPLANATION OF DRAWINGS

FIG. 1 is a sectional view of an embodiment of the rotating electric machine according to the present invention in the state of including axis.

FIG. 2 is a view of the stator shown in FIG. 1, viewing from the axial direction.

FIG. 3 is a sectional view of another embodiment of the rotating electric machine according to the present invention in the state of including axis.

FIG. 4 is a view of the stator shown in FIG. 3, viewing from the axial direction.

FIG. 5 is a sectional view of further another embodiment of the rotating electric machine according to the present invention in the state of including axis.

FIG. 6 is a sectional view of the rotating electric machine shown in FIG. 5 at an approximate center position of the thickness thereof, viewing from the axial direction.

FIG. 7 is a view illustrating the construction of still another embodiment of the rotating electric machine according to the present invention.

FIG. 8 is a sectional view of the rotating electric machine shown in FIG. 7 at an approximate center position of the thickness thereof, viewing from the axial direction.

FIG. 9 is a view of a permanent magnet, viewing from the thickness direction.

FIG. 10 is a front view of a different rotating electric machine onto which the present application is applied.

FIG. 11 is a view which illustrates a rotating electrical motor in the prior art.

FIG. 12 is a view of the rotating electric machine shown in FIG. 11, viewing from the axial direction.

### MODES FOR CARRYING OUT THE INVENTION

Now, the present invention will be described with reference to the drawings.

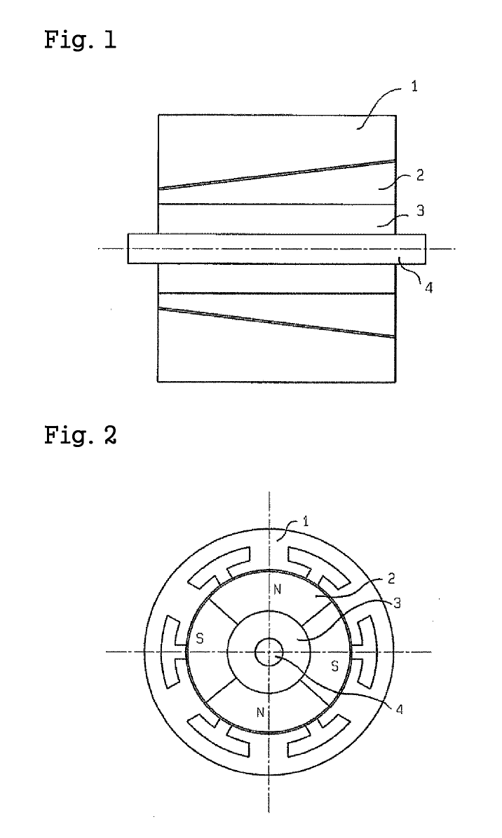

FIG. 1 shows an embodiment of the construction of a rotating electric machine according to the present invention, which is an example of BLOC motor, in the state of including rotating axial core. FIG. 2 is a view of the rotating electric machine shown in FIG. 1, viewing form the direction of the rotating axial core. In FIG. 1 and FIG. 2, the numeral 1 denotes a stator iron core which is provided with six members of wire-winding poles. The inner diameter portion of the stator iron core becomes gradually smaller with a linear or step-wise degression from one side to another side in its axial direction, in other words, the inner diameter portion shows a truncated conical shape of which one side in its axial direction has a maximum diameter and another side has a minimum diameter. Incidentally, wires individually wounded to six members of the wire-winding poles of the stator iron core 1 have omitted from the illustration. The numeral 2 denotes a rotor, which comprises permanent magnet(s), and in which four numbers of poles are formed with an arrangement that the north poles and the south poles are arrayed alternately in its circumferential direction. The permanent magnet(s) may be composed of one member, or four segments. Herein, the outer peripheral portion of the rotor 2, which is opposed to the stator iron core via an air gap, is shaped so as to show a truncated conical shape corresponding the shape of the inner diameter portion of the stator iron core 1. The numeral 3 denotes an inner ring made of magnetic iron, which functions as back yoke of the rotor 2 and inner ring between the rotor 2 and the rotating axis 4. The rotating electric motor thus constructed is easily assembled when the rotor is inserted into the stator iron core, because the air gap thereof has the tapered shape, as compared with the case of the conventional rotating electric motor of which air gap is parallel to its axis. In addition, since the opposed area between the stator iron core and the rotor at the air gap becomes larger, an advantage in enhancing the torque can be yielded. Incidentally, right and left brackets and bearings, for supporting and holding rotatably the rotor and the stator iron core while ensuring the formation of the air gap between them, have also omitted from the illustration.

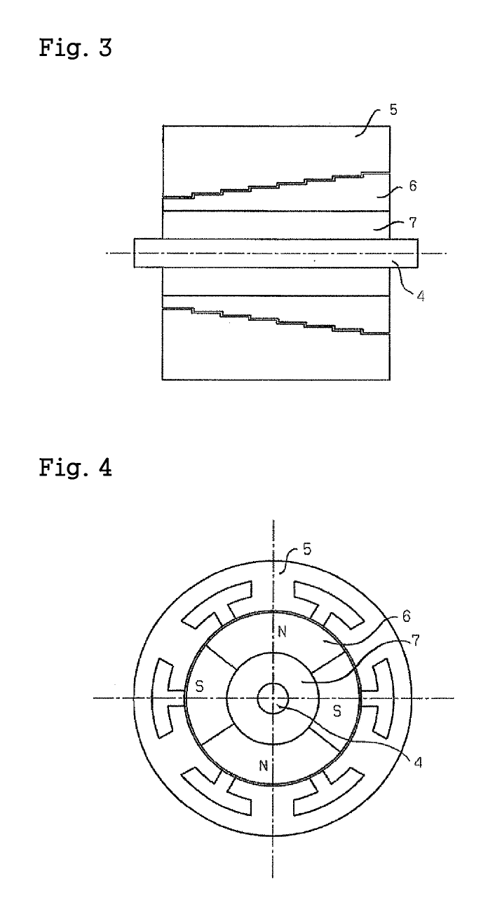

FIG. 3 shows another embodiment of the construction of a rotating electric machine according to the present invention, which is an example of BLDC motor, in the state of including rotating axial core. FIG. 4 is a view of the rotating electric machine shown in FIG. 3, viewing form the direction of the rotating axial core.

In FIG. 3 and FIG. 4, the numeral 5 denotes a stator iron core which is provided with six members of wire-winding poles. The inner diameter portion of the stator iron core shows a step-wise tapered shape of which one side in its axial direction has a maximum diameter and another side has a minimum diameter. Incidentally, wires individually wounded to six members of the wire-winding poles of the stator iron core 5 as well as right and left brackets have omitted from the illustration. The numeral 6 denotes a rotor, which comprises permanent magnet (s) and in which four numbers of poles are formed with an arrangement that the north poles and the south poles are arrayed alternately in its circumferential direction. The permanent magnet(s) may be composed of one member, or four segments. Herein, the outer peripheral portion of the rotor 6, which is opposed to the stator iron core 5 via an air gap, is shaped so as to show a step-wise tapered shape corresponding the shape of the inner diameter portion of the stator iron core 5. The numeral 7 denotes an inner ring made of magnetic iron, which functions as back yoke of the rotor 6 and inner ring between the rotor 6 and the rotating axis 4. In the embodiment shown in FIG. 3, although the shapes of the inner diameter portion of the stator iron core and the outer diameter portion of the rotor are illustrated as the step-wise tapered shape, the shapes of them are not limited to such an illustration. Other configurations, for instance, a truncated conical shape of which surface draws a continuous curved cycle or a continuous pyramidal cycle, which can also give a larger opposed area at the air gap than that in the case of the liner tapered shape as shown in FIG. 1, or a conical shape of which surface draws any combination of steps, curves and triangles, may be also used. Namely, any configurations in which a waveform having a short cycled projections-and-depressions is added to the tapered outline of a conical shape may be used. The term “step-wise shape” used in the annexed Claims, with reference to the shape of the air gap, is intended to involve such configurations as mentioned above, and thus should be interpreted as such a broader meaning.

In the rotating electric machine according to the present invention, as shown in FIG. 1 and FIG. 3, the wire winding axis thereof lies in the radial direction, and thus, the wire winding axis and the rotating axial core cross each other orthogonally. On the other hand, in the conventional axial gap type rotating electric machine, the wire winding axis thereof lies in the axial direction, and thus, the wire winding axis is parallel to the rotating axial core.

The rotating electric motor thus constructed is easily assembled when the rotor is inserted into the stator iron core, because the air gap thereof has the step-wise tapered shape, as compared with the case of the conventional rotating electric motor of which air gap is parallel to its axis. In addition, since the opposed area between the stator iron core and the rotor at the air gap in the rotating electric motor shown in FIG. 3 is still about \sqrt{2} (the square root of two) times larger than that in the case of the liner tapered shape as shown in FIG. 1, an further advantage in enhancing the torque can be yielded.

Herein, the stator iron cores 1, 5, and/or the rotors 2, 6 may be formed individually with a silicon steel plates lamination. However, in the case of the conical shape and the step-wise shape as shown in FIG. 1 (denoted as the numeral 1) and FIG. 3 (denoted as the numeral 5), various shapes and sizes of press cutting dies are required for such a lamination, and thus a problem of an increase in the manufacturing cost will arise. On the other hand, when the so-called dust core, that is manufactured by adding and mixing an appropriate resin powder which functions as a binder or a lubricant to an iron powder, and then compressing and heat-treating the resultant mixture is used as the material for the parts denoted as the numerals 1, 5, it is possible to obtain a proper shape's one at low cost easily.

As a generalization, in the case of the permanent magnet type rotating electric motor, since the so-called relative permeability μᵣ, that is, the ratio between the permeability of the magnetic iron which constitutes magnetic circuit and the permeability of air which constitute the air gap, is a large value of about 1000, it is understood that about 90% or so of the magnetomotive force of the permanent magnet is consumed at the air gap portion, in consideration of the following equation (3) that is obtained by substituting the following equation (1) into the following equation (2):.

μᵣ=μᵢ/μ₀ (1)

AT=(B_{g}/μ₀)L_{g}+(Bᵢ/μᵢ)Lᵢ (2)

AT=(B_{g}/μ₀))L_{g}(1+(Lᵢ/L_{g})(1/μᵣ) (3)

wherein, B_{g}: magnetic flux density of the air gap; Bᵢ: magnetic flux density of the iron core part; μₒ: permeability of air; μᵢ: permeability of iron; L_{g}: length of the air gap; Lᵢ: length of the iron core part; AT: magnetomotive force of the permanent magnet or the electromagnet.

Namely, in the case that the sectional area of the magnet in the magnet circuit is equal to the sectional area of the iron core in the magnet circuit, B_{g}=Bᵢ, and thus, the equation (3) is obtained. The first member of the equation (3) comes to represent the moiety of the magnetomotive force that is consumed at the air gap portion. Herein, assuming that (Lᵢ/L_{c})=100, since (1/μᵣ)=1/1000, the value of the first member of the equation (3) is about ten times larger than the second member of the equation (3). As described above, since 90% of AT, i.e., the magnetomotive force of the permanent magnet or the magnetomotive force of the electromagnet is consumed at the air gap portion, it can be understood that the performance of the rotating electric motor depend on the air gap up to the extent of 90%. In order to decrease the consumption of the magnetmotive force at the air gap, it is effective to increase the gap permeance. The gap permeance is proportional to the opposed area between the stator and the rotor. The present invention pays attention to this respect, and thus, offers an effective means to increase this opposed area, in order to accomplish a large enhancement in efficiency of the rotating electric machine.

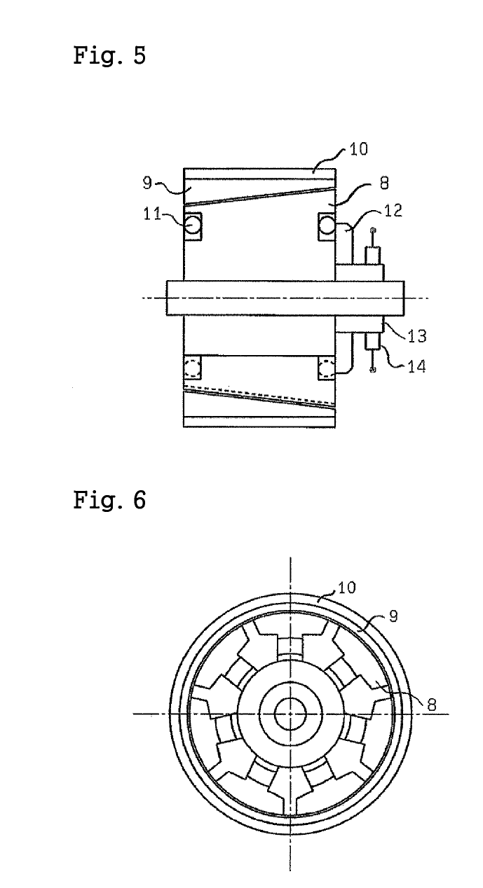

FIG. 5 is a sectional view of further another embodiment of the rotating electric machine according to the present invention, which is an example of direct current electric motor, in the state of including axis. FIG. 6 is a sectional view of the rotating electric machine shown in FIG. 5 at an approximate center position of the thickness thereof, viewing from the axial direction. In FIG. 5 and FIG. 6, the numeral 8 denotes a rotor iron core, the outer peripheral portion of which shows a truncated conical shape, and which is opposed to a permanent magnetic stator 9, such as ferrite or the like, the inner diameter portion of which shows a similar truncated conical shape, via a tapered air gap. The numeral 10 denotes a back yoke-cum-stator flame for the stator 9. In these figures, as in the previous figures, right and left brackets and bearing have omitted from the illustration. The numeral 11 denotes a winding, and the numeral 12 denotes a terminal of the winding, and this terminal is connected to a commutator which is denoted by the numeral 13. The numeral 14 denotes a brush made of carbon or the like, and this brush is it is arranged so as to come into contact with the cummutator 13 while being sliding. When a direct current voltage is given through the brush 14, this structure performs rotation operation as a direct current electric motor. As shown in FIG. 6, in this embodiment, the rotor iron core 8 is a structural example that is provided with seven members of wire-winding poles.

In the case that the commutator 13 and the brush 14 are omitted from the construction shown in FIG. 5, the construction shown in FIG. 5 and FIG. 6 may be used as an outer rotor type rotating electric machine in addition to the aforementioned direct current electric motor. Namely, when the parts in the side including the winding 11 is set as a stator and an appropriate alternating current voltage is applied to the winding, a rotating magnetic field is generated. Thus, the permanent magnetic stator 9 is converted to a permanent magnetic rotor 9, the rotating iron core 8 is converted to a stator iron core, and therefore the outer rotor type rotating electric machine is constituted. Both in the cases of the former direct current electric motor and the latter outer rotor type rotating electric machine, the enlargement in the opposed area at the air gap contributes to enhancement in the efficiency of the rotating electric machine.

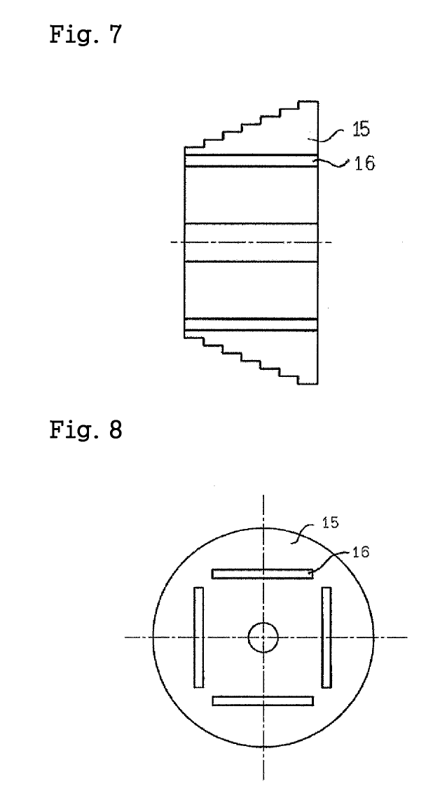

FIG. 7 shows a constructional example of an interior permanent magnet type rotor which is able to be used in a BLOC motor which is still another embodiment of a rotating electric machine according to the present invention. FIG. 8 is a sectional view of the rotor shown in FIG. 7 at an approximate center position of the thickness thereof, viewing from the axial direction. With respect to the BLOC motor, there are two types, i.e, the surface permanent magnet type and the interior permanent magnet type as the permanent magnet rotor. The present invention can be applied to both of these types.

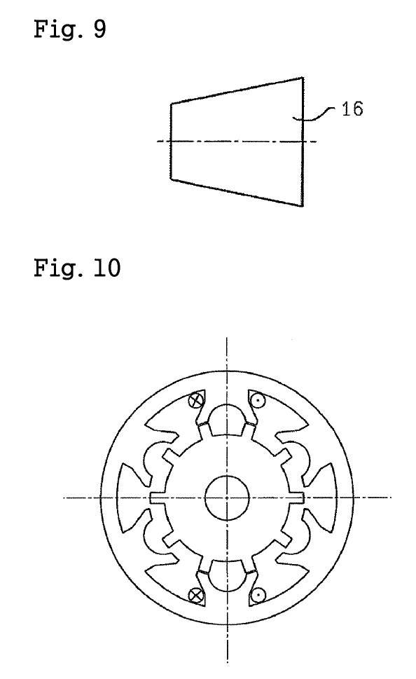

The aforementioned embodiments shown in FIGS. 1-4 are examples of using the surface permanent magnet type rotor. On the other hand, the embodiment shown in FIG. 7 and FIG. 8 is an example of using the interior permanent magnet type rotor. Although FIG. 7 and FIG. 8 illustrate only the rotor, a stator to be used in combination with this rotor is almost same with those which are illustrated in FIGS. 1-4. The numeral 15 denotes a rotor iron core, and this rotor iron core is an example for 4 poles' iron core. Into each of four members of slot holes digged in the rotor iron core 15, a plate-like permanent magnet denoted as the numeral 16 is stored individually. In this embodiment, the outer peripheral portion of the rotor iron core 15 shows a step-wise shape. Thus, although the rotor iron core may be formed with a silicon steel plates lamination, various shapes and sizes of press cutting dies are required for such a lamination, and thus a problem of an increase in the manufacturing cost will arise. On the other hand, when the rotor iron core is manufactured by using dust core, it is possible to mold it as one article with using a die, and thus it becomes possible to obtain the iron core at low cost. FIG. 9 shows the outline shape of the permanent magnet 16. As shown in this figure, the permanent magnet 16 is formed so as to show a trapezoid shape when viewing from the thickness direction. Thus, their insertion to the slot holes becomes easier. Herein, if the slot hole 15 has a curved outline, the permanent magnet 16 to be used may has a curved surface so as to be corresponded with the shape of the slot hole 15.

FIG. 10 is a front view of a different rotating electric machine onto which the present application is applied. The aforementioned embodiment shown in FIG. 1 is an example in which the number of the wire-winding poles of the stator is six. The embodiment shown in FIG. 10 is a structural example in which the similarly formed, six members of the wire-winding poles of the stator are individually split into two parts at their peripheral end so as to form two teeth each, and the rotor has ten members of salient poles made of magnetic material. The structure of the stator is also referred as to “inductor structure”, and such a structure have been often applied to the hybrid type stepping motor (hereinafter, referred as to HBSTM) in which the stepping angle is designed so as to be smaller and thus the positioning accuracy is heightened. Herein, the construction shown in FIG. 10 is an example of SR motor. When the number of the teeth of rotor is increased from four to ten, the torque obtained is also increased according to the increment of the number of the teeth. Because of this reason, the stator of such an inducer structure. In the case of the SR motor, the rotor thereof possesses only the teeth made of magnetic material. On the other hand, in the case of the HBSTM, the rotor thereof has ten numbers in total of opposite poles which are formed with an arrangement the north poles and the south poles are arrayed alternately in its circumferential direction. Both in the cases of the SR motor and the HBSTM, the conical shape air gap structure or the step-wise shape air gap structure according to the present invention is applicable.

Incidentally, the embodiment shown in FIG. 10 can be considered as a concrete example of SR motor according to the above-mentioned fifth means, providing that it is a three phase system, and m=6, p=2 and r=10. As for the rotor, a permanent magnet type one which is magnetized so that q numbers of opposite poles are formed with an arrangement that the north poles and the south poles are arrayed alternately in its circumferential direction is also usable. Providing that q=10, such a permanent magnet type can be used in combination with the stator shown in FIG. 10, and as the result, a BLDC motor or stepping motor having twenty poles is constructed.

According to such a constructive feature, it is also possible to constitute a rotating electric machine where the rotor is arranged to the outer peripheral of the stator. The above mentioned sixth means is applicable for such a conversion of the rotor arrangement in the structure shown in FIG. 10 so as to be outer side.

In the case that the iron core to be used in the present invention is manufactured by powder compression molding for the dust core, the iron core may be molded as one piece. Alternatively, the iron core may be obtained by molding plural numbers of parts as split iron core parts appropriately, winding wire to each part, and thereafter coalescing the wire wound split iron core parts, as such a case that the size of the iron core is large. When splitting in plural parts, it becomes possible to enlarge the size of the iron core for the rotating electric motor without establishing expensive press machines more in accordance with the size variation. Incidentally, in order to accomplish the powder compression, about 800 MPa of pressure is required, and thus the press machines used for this compression become expensive. Further, when such a split type dust core is employed as the iron core, it is possible to enhance dramatically the space factor of winding to 60% or more. Since the torque of the rotating electric machine is in proportion to the square root of the area for the wound copper wire, when the space factor of winding comes to be 60% that is double 30% that is obtained in the conventional structure, it is possible to enhance the torque about \sqrt{2} (the square root of two) times larger than that of the conventional structure. As described above, according to the step-wise shape air gap of the present invention, it is possible to enhance the torque about \sqrt{2} (the square root of two) times larger. Therefore, when the step-wise shape air gap is adopted in combination with the split type dust core, it becomes further possible to attain a double torque of the conventional structure. Although the dust core as mentioned above has a disadvantage that its magnetic flux density is smaller than that of the silicon steel plates' lamination type core, it can be said that the dust core is suitable for accomplishing the high efficiency. Because in the case of utilizing the overhang configuration, the areas opposed to the rotor becomes larger.

The larger the inclined angle in the liner conical shape air gap or the step-wise conical shape air gap according to the present invention, that is, what is called “cone angle” becomes, the more inclined the rotating electrical machine according to the present invention will be similar in performance to the axial gap type rotating electrical machine and the less inclined it will be similar to the radial gap type rotating electrical machine. Providing that the inclined angle comes near 45°, a rotating electric machine of the middle performance of the radial gap type and the axial gap type will be obtained. However, as described above, the wire winding axis of the rotating electrical machine according to the present invention lies in the radial direction, and thus, the wire winding axis and the rotating axial core cross each other orthogonally, while the wire winding axis of the conventional axial gap type rotating electric machine lies in the axial direction, and thus, the wire winding axis is parallel to the rotating axial core. This is a fundamental difference between them.

Moreover, the present invention is not only utilized in the electric motor, but also be utilized in an electric generator.

In addition, it is possible to prepare a large power rotating electric machine, for instance, when a part having the shape of stator iron core as shown in FIG. 1 or FIG. 3 is connected with another part having the mirror image of the shape of the former stator iron core, that is, the one that has a shape reversed in the axial direction, and wire-winding are provided to the connected stator iron core, while a part having the shape of the rotor as shown in FIG. 1 or FIG. 3 is similarly connected to another part having the mirror image of the shape of the former rotor so as to have the same rotating axis. Although the disassembling of such a construction becomes difficult, but the assembling thereof per se is possible.

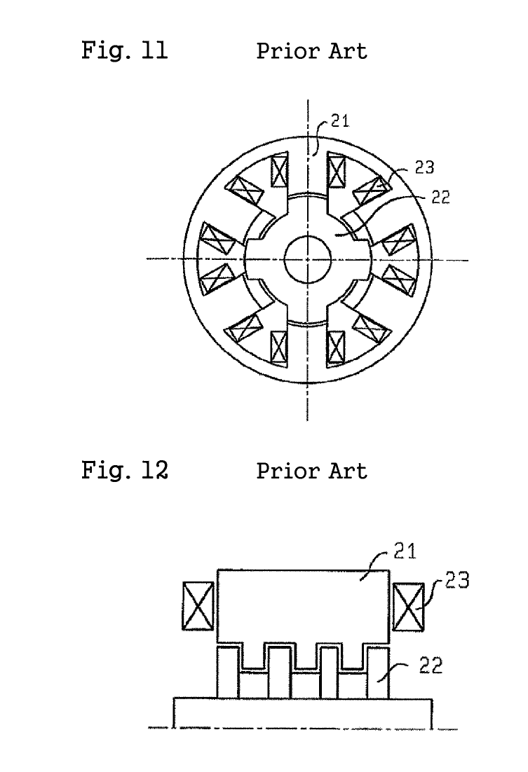

FIG. 11 is a view which illustrates a rotating electrical motor in the prior art. FIG. 12 is a view of the rotating electric machine shown in FIG. 11, viewing from the axial direction.

FIG. 12 indicates the technology corresponding to the patent literature 1. In FIG. 12, the numeral 12 denotes a stator, the numeral 22 denotes a rotor, and the numeral 23 denote a wire wound to the stator. In FIG. 12, the rotating electric motor is constituted so that the air gap is formed by engaging concavo-convex shapes with each other, but not formed linearly along the rotating axis. Thus, the substantial opposed area at the air gap becomes larger and the enhancement in the efficiency and the torque of the rotating electric machine can be attained. However, since the air gap of this rotating electric machine is not formed linearly, it is impossible to manufacture the rotor and the stator separately and assemble them into this machine so that the rotor is inserted into the stator. Therefore, an extended times are required to accomplish the assemblage of this machine including the wire winding operation as compared with a normal air gap type rotating electric machine in which the air gap is formed linearly along the axis direction, and the manufacturing cost becomes higher. The fact that the assemblage is difficult will induce a certain degression in the yield, some defects, and some accidents in working easily, In addition, some troubles in the reliability also will be caused easily. Moreover, when needing an overhaul in its maintenance, the work on the overhaul is extremely difficult. On the other hand, the present invention achieves a rotating electric machine which enjoys a high torque and high efficiency while assemblage and disassembling of it are extremely easy, as mentioned above.

### INDUSTRIAL UTILITY

The rotating electric machine according to the present invention can use for an electric motor or an electric generator, and it is suitable for realizing a durable, thin, light weight and compact product at low cost, and for making to a high torque, and making to highly effective, and thus it is extremely practicable. Therefore, a large contribution will be expected industrially.

### EXPLANATION OF NUMERALS

1, 5 stator iron core
11, 23 winding
2, 6, 22 rotor
4 rotation axis
3, 7 inner ring
8, 15 rotor iron core
9 permanent magnet stator
10 back yoke
12 terminal of winding
13 commutator
16 permanent magnet
14 brush
21 stator

1. A rotating electric machine comprising a rotor and a stator,
wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, and the inner diameter portion of which becomes gradually smaller with a linear or step-wise degression from one side to another side in its axial direction so as to form an air gap in a tapered or step-wise shape with the rotor,
wherein the rotor is one member selected from the group consisting of
(a) a surface permanent magnet type rotor, an outer peripheral portion of which becomes gradually smaller with a linear or step-wise degression from one side to another side in the axial direction so as to form the air gap in the tapered or step-wise shape with the stator, and the surface of which is magnetized by using permanent magnets so that n numbers of poles are formed with an arrangement that the north poles and the south poles are arrayed alternately in its circumferential direction; and
(b) an interior permanent magnet type rotor, an outer peripheral portion of which becomes gradually smaller with a linear or step-wise degression from one side to another side in the axial direction so as to form the air gap in the tapered or step-wise shape with the stator, and in which permanent magnets are embedded in holes provided on an iron core of the rotor in order that the iron core is magnetized so that n numbers of poles are formed with an arrangement that the north poles and the south poles are arrayed alternately in its circumferential direction,
wherein m represents a positive integer of two or more, and n represents a positive even number, and
wherein the stator and the rotor are engaged rotatably so as to be opposed to each other.

2. A rotating electric machine comprising a rotor and a stator,
wherein the stator has an inner diameter portion which becomes gradually smaller with a linear or step-wise degression from one side to another side in its axial direction so as to form an air gap in a tapered or step-wise shape with the rotor, and which is magnetized by adopting a surface permanent magnet type or an interior permanent magnet type configuration so that n numbers of poles are formed in its circumferential direction,
wherein the rotor is made of magnetic iron, a wire-winding axis and a rotating axial core of which cross each other orthogonally, and which comprises an iron core which has m numbers of wire-winding salient-poles which are arranged and distributed radially, and the outer peripheral portion of which becomes gradually smaller with a linear or step-wise degression from one side to another side in its axial direction so as to form the air gap in the tapered or step-wise shape with the stator,
wherein m represents a positive integer of two or more, and n represents a positive even number, and
wherein the stator and the rotor are engaged rotatably so as to be opposed to each other.

3. A rotating electric machine comprising a rotor and a stator,
wherein the rotor has an inner diameter portion which becomes gradually smaller with a linear or step-wise degression from one side to another side in its axial direction so as to form an air gap in a tapered or step-wise shape with the stator, and which is magnetized by adopting a surface permanent magnet type or an interior permanent magnet type configuration so that n numbers of poles are formed in its circumferential direction,
wherein the stator is made of magnetic iron, a wire-winding axis and a rotating axial core of which cross each other orthogonally, and which comprises an iron core which has m numbers of wire-winding salient-poles which are arranged and distributed radially, and the outer peripheral portion of which becomes gradually smaller with a linear or step-wise degression from one side to another side in its axial direction so as to form the air gap in the tapered or step-wise shape with the rotor,
wherein m represents a positive integer of two or more, and n represents a positive even number, and
wherein the stator and the rotor are engaged rotatably so as to be opposed to each other.

4. A rotating electric machine comprising a rotor and a stator,
wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, and the inner diameter portion of which becomes gradually smaller with a linear or step-wise degression from one side to another side in its axial direction so as to form an air gap in a tapered or step-wise shape with the rotor,
wherein the rotor is made of magnetic iron, and which comprises n numbers of salient-poles and the outer peripheral portion of which becomes gradually smaller with a linear or step-wise degression from one side to another side in its axial direction so as to form the air gap in the tapered or step-wise shape with the stator,
wherein m represents a positive integer of two or more, and n represents a positive even number, and
wherein the stator and the rotor are engaged rotatably so as to be opposed to each other.

5. A rotating electric machine comprising a rotor and a stator,
wherein the stator is made of magnetic iron, a wire-winding axis and a rotating axial core of which cross each other orthogonally, and an inner diameter portion of which is provided with an iron core which has m numbers of wire-winding salient-poles which are arranged and distributed circumferentially, wherein each individual wire-winding salient-pole has p numbers of teeth, and the inner diameter portion of which becomes gradually smaller with a linear or step-wise degression from one side to another side in its axial direction so as to form an air gap in a tapered or step-wise shape with the rotor,
wherein the rotor is positioned at the inner diameter portion of the stator, and the outer peripheral portion of which becomes gradually smaller with a linear or step-wise degression from one side to another side in its axial direction so as to form the air gap in the tapered or step-wise shape with the stator, and which is magnetized by permanent magnets so that q numbers of opposite poles are formed with an arrangement that the north poles and the south poles are arrayed alternately in its circumferential direction, or which comprises r numbers of salient poles in its circumferential direction,
wherein m, p and q represent an individual positive integer of two or more, and r represents a positive even number, and
wherein the stator and the rotor are engaged rotatably so as to be opposed to each other.

6. A rotating electric machine comprising a rotor and a stator,
wherein the stator is made of magnetic iron, a wire-winding axis and a rotating axial core of which cross each other orthogonally, and an outer peripheral portion of which is provided with an iron core which has m numbers of wire-winding salient-poles which are arranged and distributed circumferentially, wherein each individual wire-winding salient-pole has p numbers of teeth, and the outer peripheral portion of which becomes gradually smaller with a linear or step-wise degression from one side to another side in its axial direction so as to form an air gap in a tapered or step-wise shape with the rotor,
wherein the rotor is positioned outside of the stator, and the inner diameter portion of which becomes gradually smaller with a linear or step-wise degression from one side to another side in its axial direction so as to form the air gap in the tapered or step-wise shape with the stator, and which is magnetized by permanent magnets so that q numbers of opposite poles are formed with an arrangement that the north poles and the south poles are arrayed alternately in its circumferential direction, or which comprises r numbers of salient poles in its circumferential direction,
wherein m, p and q represent an individual positive integer of two or more, and r represents a positive even number, and
wherein the stator and the rotor are engaged rotatably so as to be opposed to each other.

7. The rotating electric machine according to claim 1, wherein the magnetic iron is dust core.

8. The rotating electric machine according to claim 1, wherein the magnetic iron is both of dust core and silicon steel plates.

9. The rotating electric machine according to claim 7, wherein a portion made of the dust core is provided with an overhang configuration having a wire-winding slot.

10. The rotating electric machine according to claim 1, wherein the permanent magnets used in the surface permanent magnet type stator or rotor are magnetized with an angle which is not orthogonal to the rotating axis.

11. The rotating electric machine according to claim 1, wherein the permanent magnets used in the interior permanent magnet type stator or rotor, or split type permanent magnets used in the surface permanent magnet type stator or rotor show a trapezoid shape or a curved surface trapezoid shape in the thickness direction.
